(19) United States
(12) Patent Application Publication
(10) Pub. No.: US 2001/0003922 A1
(43) Pub. Date: Jun. 21, 2001

(54) Arrangement and method for measuring the flow velocity of a gas

(76) Inventor: Dieter Engel, Reinfeldt (DE)

Correspondence Address: Walter Ottesen, Patent Attorney, P.O. Box 4026, Gaithersburg, MD, 20885-4026, US

(21) Appl. No.: 09/733,045

(22) Filed: Dec. 11, 2000

(30) Foreign Application Priority Data
Dec. 15, 1999 (DE) 199 60 437.1

(51) Int. Cl. G01F 1/68

(52) U.S. Cl. 73/204.11

(57) ABSTRACT

The invention relates to a measuring arrangement for measuring the flow velocity of a gas. With a single measuring sensor, a physical quantity of the gas as well as the gas temperature can be measured. During a first measuring phase in which the measuring sensor is heated to an operating temperature by a heating current, a first measurement quantity is determined from the change of the heating current caused by the physical quantity. During a second measuring phase, the measuring sensor is connected to a resistance measuring device and the heating current of the measuring sensor is reduced in such a manner that the inherent warming of the measuring sensor is small compared to the operating temperature. A second measurement quantity is determined from the resistance of the measuring sensor which is proportional to the temperature of the gas.

### BACKGROUND OF THE INVENTION

An arrangement for measuring the flow velocity of a gas is disclosed in U.S. Pat. 3,645,133. A measuring sensor is disposed in a cylindrical gas channel and heated to an operating temperature. The measuring sensor is part of a measuring bridge and a measurement value, which is proportional to the flow velocity of the gas, results from the bridge unbalance. A further measuring sensor is present to compensate for the temperature influence and this measuring sensor influences the current supply device of the measuring bridge. Flow measuring devices of this kind are preferred for use in ventilating systems in order to measure the gas volume which is exhaled or inhaled by a patient or is also used to measure the minute volumes. A measurement adapted to the patient is sought. In order to not unnecessarily affect the patient during the measurement, the measuring device should be configured as simple as possible and be equipped with a minimum of measuring sensors so that the number and the strength of the supply cables is limited only the extent absolutely necessary.

### SUMMARY OF THE INVENTION

It is an object of the invention to provide an arrangement having a measuring sensor which can be used for measuring the gas temperature as well as for measuring an additional physical quantity of the gas. It is also an object of the invention to provide a method for carrying out the measurement.

The method of the invention is for measuring the temperature and a further physical quantity of a gas present in a channel. The method includes the steps of:

(a) mounting a measuring sensor in the channel;

(b) providing a supply circuit for supplying a heating current to the measuring sensor to heat the measuring sensor to an operating temperature increased beyond the temperature of the gas;

(c) during a first measuring phase in which the measuring sensor is at the operating temperature, determining a first measurement quantity from the change of the heating current caused by the physical quantity of the gas;

(d) during a second measuring phase, connecting the measuring sensor to a resistance measuring device and dimensioning the heating current of the measuring sensor in such a manner that the inherent warming of the measuring sensor is small compared to the operating temperature after step (c); and,

(e) determining a second measurement quantity from the resistance of the measuring sensor which is proportional to the temperature of the gas.

The arrangement of the invention is for determining the temperature and a further physical quantity of a gas in a channel. The arrangement includes: a measuring sensor disposed in the channel; a supply circuit connected to the measuring sensor for supplying a heating current thereto for heating the measuring sensor to an operating temperature so as to be increased relative to the temperature of the gas; a resistance measuring device; a control circuit for connecting the measuring sensor during predetermined measuring phases either to the supply circuit or the resistance measuring device; and, the control circuit being so configured that, during a first measuring phase wherein the measuring sensor is connected to the supply circuit, a first measurement quantity can be determined from the change of the heating current which is caused by the physical quantity and, during a second measuring phase wherein the measuring sensor is operatively connected to the resistance measuring device, the heating current is adjusted to such a value that the inherent heating of the measuring sensor is small compared to the operating temperature; and, that a second measurement quantity, which is proportional to the temperature of said gas, can be determined from the resistance of the measuring sensor.

The advantage of the invention is essentially that the current, which flows through the measuring sensor, can be changed by a control circuit in such a manner that the flow velocity or the material characteristics of the gas can be determined during a first measuring phase wherein the measuring sensor is at its operating temperature and, thereafter, during a second measuring phase, the measuring sensor is connected to a resistance measuring device and the heating current is so reduced that the inherent heating of the measuring sensor is small compared to the operating temperature, especially that the inherent heating of the measuring sensor is small compared to the overtemperature referred to the gas temperature when measuring the flow velocity. The operating temperature of the measuring sensor is the sum of the gas temperature and the overtemperature.

The overtemperature is held to a constant value to measure the flow velocity. For this reason, the gas temperature must be known for inputting the operating temperature of the measuring sensor. The operating temperature of the measuring sensor usually lies in a range between 130° C. to 180° C. during the first measuring phase and the measuring sensor is held to the constant overtemperature by the heating current. Because of the cooling of the measuring sensor due to the velocity of the gas flow, the supplied power is increased and the increase in power is an index for the velocity of the gas flow.

For measuring the gas temperature, the measuring sensor is connected via the control circuit to a resistance measuring device during the second measuring phase and the heating current is reduced in such a manner that the inherent heating is small relative to the operating temperature or the overtemperature. An inherent heating of the measuring sensor, which deviates from the reference temperature by the order of magnitude of 1%, is generally still tolerable. If a higher inherent heating adjusts during the temperature measurement, the gas temperature is measured in the region of greater flow velocities. If the inherent heating of a measuring sensor lies between 10° C. and 15° C., for example, for a heating current of 10 milliamperes, then the temperature measurement is undertaken for a gas flow of approximately 10 liters per minute. For the temperature measurement, a short time window which lies between 20 milliseconds and 50 milliseconds is sufficient. The temperature measurement preferably takes place with a time delay of 20 to 50 milliseconds after the heating current is reduced. When analyzing respiratory gas, flow and temperature measurements are executed at least once per inhalation or exhalation.

It is especially advantageous to mount a further measuring sensor having an air resistance body in the channel in such a manner that the air resistance body lies in the flow influencing region of one of the measuring sensors. The further measuring sensor is likewise heated to an operating temperature. By comparing the measuring signals, which are supplied from the measuring sensors, the flow direction can be determined in addition to the flow velocity and gas temperature.

Arrangements having two measuring sensors, which are heated to a constant operating temperature, and an air resistance body are known from the state of the art but the arrangement according to the invention permits additionally the measurement of temperature without the number of measuring sensors being increased.

In the arrangement having two measuring sensors, an especially advantageous embodiment provides that one measuring sensor is continuously heated to the constant overtemperature compared to the gas temperature in order to measure the flow velocity; whereas, the other measuring sensor is used for detecting the flow direction and for measuring the temperature. To determine the flow direction, both measuring sensors are at the operating temperature; whereas, the temperature measurement is carried out with a reduced heating current.

### BRIEF DESCRIPTION OF THE DRAWINGS

The invention will now be described with reference to the drawings wherein:

FIG. 1 is a schematic of the measuring arrangement according to the invention;

FIG. 2 is a schematic of a first supply circuit for a measuring sensor; and,

FIG. 3 is a schematic showing the configuration of a second supply circuit.

### DESCRIPTION OF THE PREFERRED EMBODIMENTS OF THE INVENTION

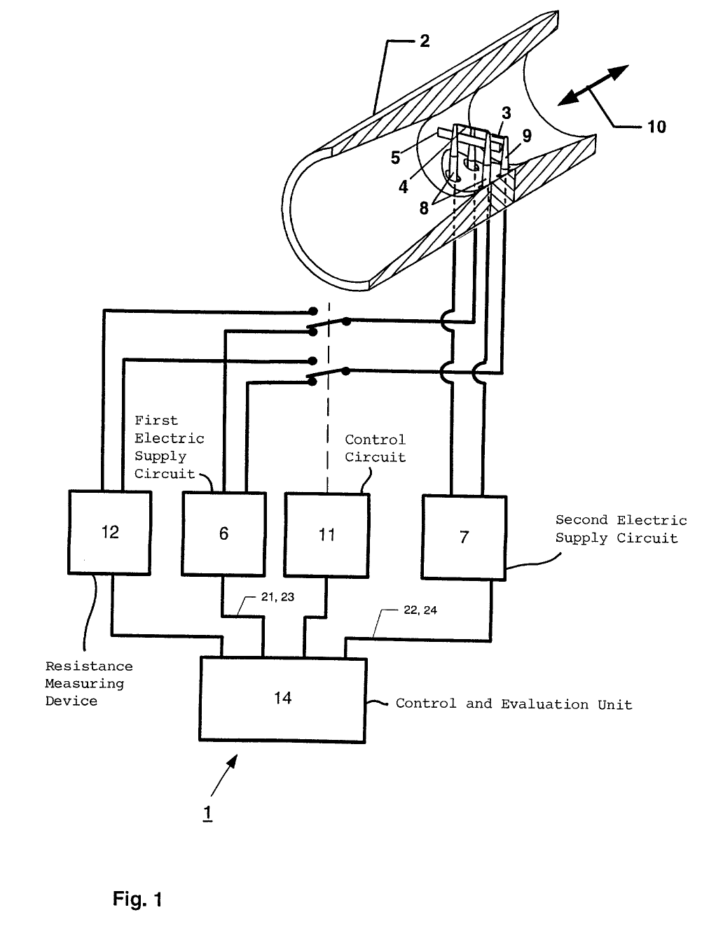

FIG. 1 shows schematically the configuration of a measuring arrangement 1 with which the flow velocity and the flow direction as well as the gas temperature can be measured. For this purpose, the following are mounted in a channel 2 through which a gas flows: a first measuring sensor 3, a second measuring sensor 4 and an air resistance body 5 arranged between measuring sensors 3 and 4. A first heating current flows through the first measuring sensor 3 and is generated by means of a first electric supply circuit 6. With this heating current, the first measuring sensor is heated to a constant overtemperature relative to the gas temperature. The operating temperature, which is present at the first measuring sensor 3, results from the ohmic resistance of the first measuring sensor 3.

A second electric supply circuit 7 applies a second heating current to the second measuring sensor 4. With this heating current, the second measuring sensor 4 is likewise brought to a constant overtemperature. The measuring sensors 3 and 4 are comprised of thin platinum wires which are attached to support wires 8 and 9 within the channel 2. The air resistance body 5 lies at the same elevation with the measuring sensor 3 and effects a different cooling of the measuring sensor 3 depending upon the flow direction. The possible flow directions in the channel 2 are indicated by a double arrow 10.

A control circuit 11 in the form of a switchover device is arranged in the electric line between the first measuring sensor 3 and the first supply circuit 6. With this switchover device, the first measuring sensor 3 is connected either to the first supply circuit 6 or is connected to a resistance measuring device 12. The resistance measuring device 12 is configured as a measuring bridge and applies a measuring current to the first measuring sensor 3 which is such that an inherent heating is adjusted which is small compared to the overtemperature. The heating current is so dimensioned that an inherent heating results which amounts to 1° C. to 2° C. The supply circuits 6 and 7, the control circuit 11 and the resistance measuring device 12 are all connected to a control and evaluation unit 14 which carries out all control and computing operations.

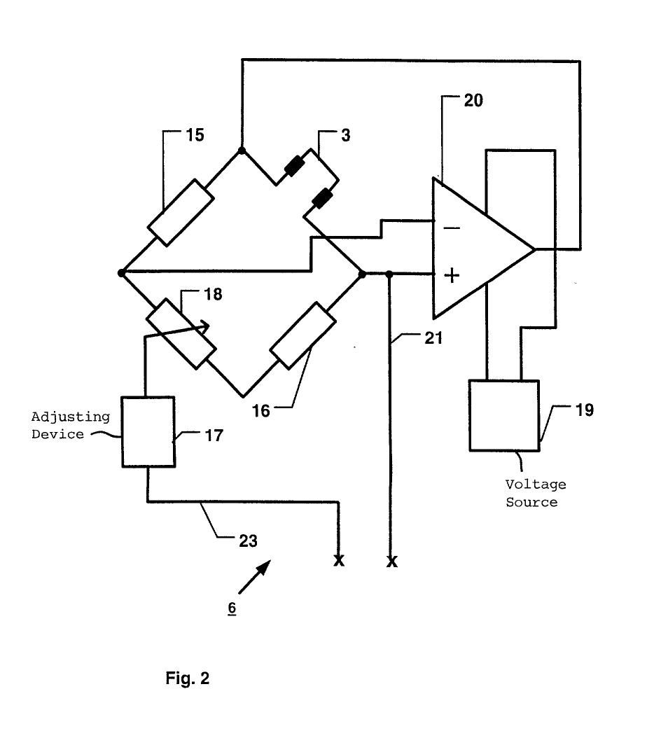

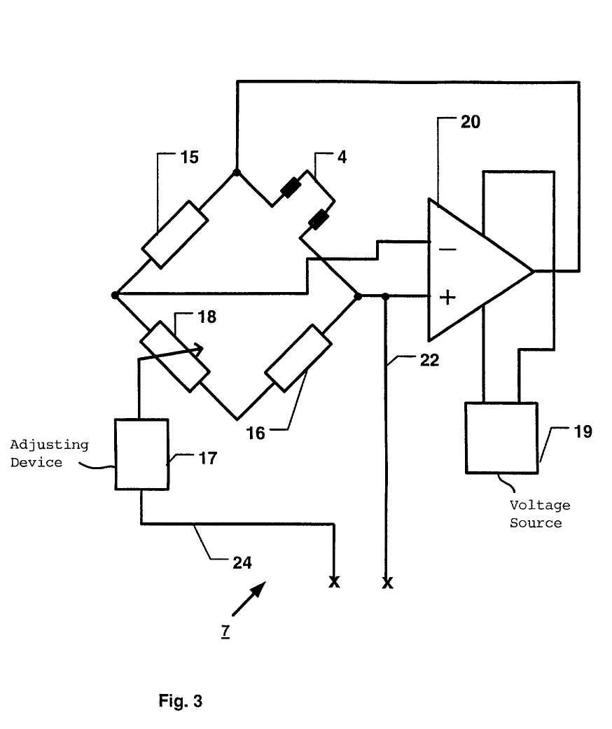

FIG. 2 shows schematically the configuration of the first supply circuit 6 for the measuring sensor 3. The supply circuits 6 and 7 are configured identically. The reference numerals of FIG. 3, which do not correspond, belong to the second supply circuit 7. The same components have the same reference numerals.

In FIG. 2, the measuring sensor 3 is connected into the bridge circuit with fixed bridge resistors (15, 16) and is connected to a bridge resistor 18 which can be changed via an adjusting device 17. In FIG. 3, the measuring sensor 4 is connected into the bridge circuit with two fixed bridge resistors (15, 16) and with a bridge resistor 18 which likewise can be changed by an adjusting device 17. The measuring bridges in FIGS. 2 and 3 are each supplied with current from a voltage source 19 via an operational amplifier 20. The diagonal voltage of each measuring bridge lies at the input of the operational amplifier 20. The output voltage of each measuring bridge is taken off at the bridge resistor 16. The measuring bridges and the adjusting devices 17 are connected via signal lines 21, 22, 23 and 24 to the control and evaluation unit 14. The measuring sensors 3 and 4 are each brought to the operating temperature via the operational amplifier 20. For this purpose, the heating currents, which are supplied by the operational amplifiers 20 and flow through the measuring sensors (3, 4), are changed so long until a constant resistance adjusts at the respective measuring sensors (3, 4) and therefore the predetermined operating temperature.

The bridge diagonal voltages change because of the gas flow and measuring voltages drop at the bridge resistors 16. These measuring voltages are transmitted via signal lines (21, 22) to the control and evaluation unit 14.

The flow direction is determined from the ratio of the measuring voltages of the measuring sensors (3, 4) to each other in the control and evaluation unit 14; whereas, the absolute value of the measurement voltages is an index for the flow velocity. Changes of the temperature of the gas, which is investigated, are compensated by the bridge resistors 18. For this purpose, the adjusting devices 17 receive a temperature signal via lines (23, 24), respectively, from the control and evaluation unit 14. The temperature signal is supplied by the resistance measuring device 12 at the time points when the first measuring sensor 3 is connected via the control circuit 11 to the resistance measuring device 12 (FIG. 1).

The measuring arrangement according to the invention is preferred for use in a respiratory gas line through which inhalation as well as exhalation takes place. At the start of an inhalation phase or an exhalation phase, the direction of the gas flow is determined by the control and evaluation unit 14 from a comparison of the measuring signals of the measuring sensors (3, 4). Thereafter, the first measuring sensor 3 is connected via control circuit 11 to the resistance measuring device 12 and the temperature measurements are carried out with a time delay of 20 to 50 milliseconds.

The resistance measuring device 12 supplies a measurement signal to the control and evaluation unit 14 which is proportional to the gas temperature. Thereafter, the first measuring sensor 3 is again connected to the first supply circuit 6 and heated to the original operating temperature. In the course of a breathing cycle, several temperature measurement signals can be determined during sequential time windows from which an average temperature value can then be computed. The measurement values for the flow velocity are continuously determined with the second measuring sensor 4 which is continuously heated to the constant operating temperature. The first measuring sensor 3 is used to measure temperature as well as to determine the flow direction. For this reason, the temperature measurement can always be undertaken within the time intervals in which no changes of flow direction are to be expected.

It is understood that the foregoing description is that of the preferred embodiments of the invention and that various changes and modifications may be made thereto without departing from the spirit and scope of the invention as defined in the appended claims.

What is claimed is:

1. A method for measuring the temperature and a further physical quantity of a gas present in a channel, the method comprising the steps of:
(a) mounting a measuring sensor in said channel;
(b) providing a supply circuit for supplying a heating current to said measuring sensor to heat said measuring sensor to an operating temperature increased beyond said temperature of said gas;
(c) during a first measuring phase in which said measuring sensor is at said operating temperature, determining a first measurement quantity from the change of said heating current caused by said physical quantity of said gas;
(d) during a second measuring phase, connecting said measuring sensor to a resistance measuring device and dimensioning said heating current of said measuring sensor in such a manner that the inherent warming of said measuring sensor is small compared to said operating temperature after step (c); and,
(e) determining a second measurement quantity from the resistance of said measuring sensor which is proportional to said temperature of said gas.

2. The method of claim 1, wherein said measuring sensor is a first measuring sensor; and, wherein said method comprises the further steps of:
(f) mounting a second measuring sensor in said channel and heating said second measuring sensor to an operating temperature;
(g) mounting an air resistance body in said channel so that said air resistance body is disposed in the flow influencing region of at least one of said measuring sensors; and,
(h) in a third measuring phase, determining a third measurement quantity proportional to the flow direction of said gas by comparing measurement values supplied by said first and second measuring sensors.

3. The method of claim 2, comprising the further step of selectively carrying out measuring steps (c) and (d) with one of said measuring sensors.

4. The method of claim 3, comprising the further step of applying said second measurement quantity to correct the temperature influence of said first measurement quantity.

5. The method of claim 3, comprising the further step of applying said first measurement quantity to correct the flow influence of said second measurement quantity.

6. The method of claim 2, comprising the further step of carrying out step (h) in advance of step (c) and (d).

7. The method of claim 2, comprising the further step of carrying out step (d) in advance of step (a).

8. An arrangement for determining the temperature and a further physical quantity of a gas in a channel, the arrangement comprising:
a measuring sensor disposed in said channel;
a supply circuit connected to said measuring sensor for supplying a heating current thereto for heating said measuring sensor to an operating temperature so as to be increased relative to said temperature of said gas;
a resistance measuring device;
a control circuit for connecting said measuring sensor during predetermined measuring phases either to said supply circuit or said resistance measuring device; and,
said control circuit being so configured that, during a first measuring phase wherein said measuring sensor is connected to said supply circuit, a first measurement quantity can be determined from the change of said heating current which is caused by said physical quantity and, during a second measuring phase wherein said measuring sensor is operatively connected to said resistance measuring device, the heating current is adjusted to such a value that the inherent heating of said measuring sensor is small compared to said operating temperature; and, that a second measurement quantity, which is proportional to said temperature of said gas, can be determined from the resistance of said measuring sensor.

9. The arrangement of claim 8, wherein said measuring sensor is a first measuring sensor and said supply circuit is a first supply circuit; and, wherein said arrangement further comprises:
a second measuring sensor;
a second supply circuit connected to said second measuring sensor for supplying a heating current thereto for heating said second measuring sensor to an operating temperature; and,
an air resistance body mounted in the flow influencing region of one of said measuring sensors.
